(19) United States
(12) Patent Application Publication
(10) Pub. No.: US 2021/0132206 A1
(43) Pub. Date: May 6, 2021

(54) METHOD AND SYSTEM FOR DETECTING A STREAM OF BUBBLES IN A BODY OF SEA WATER

(71) Applicant: SHELL OIL COMPANY, HOUSTON, TX (US)

(72) Inventors: Leslie Owuraku BAKSMATY, Houston, TX (US); Christian DE MOUSTIER, San Diego, CA (US)

(21) Appl. No.: 16/487,042

(22) PCT Filed: Feb. 19, 2018
(86) PCT No.: PCT/US2018/018593

§ 371 Date: Aug. 19, 2019

Related U.S. Application Data
(60) Provisional application No. 62/461,604, filed on Feb. 21, 2017.

(51) Int. Cl. G01S 7/539; G01N 29/032; G01N 29/26; G01S 15/02

(52) U.S. Cl. CPC G01S 7/539; G01N 29/032; G01N 2291/106; G01S 15/02; G01N 2291/02433; G01N 29/262

(57) ABSTRACT

A transmitter array as well as a receiver array for acoustic waves is deployed within the SOFAR channel in the body of sea water. Contributions to the receiver signals originating from acoustic waves that have reflected off of a stream of bubbles traversing the SOFAR channel are selected. A computer may be arranged to process receiver signals from the receiver array and programmed to select those contributions to these signals.

### CROSS REFERENCE TO RELATED APPLICATIONS

This application claims the benefit of U.S. Provisional Application No. 62/461,604, filed Feb. 21, 2017, which is incorporated herein by reference.

### FIELD OF THE INVENTION

The present invention relates to methods and systems for detecting a stream of bubbles emanating from a bubble source into a body of sea water.

### BACKGROUND OF THE INVENTION

A method for detecting hydrocarbon seepages into the sea is described in US patent application publication No. 2014/0256055. The method starts with performing a remote sensing survey and analysing the remote sensing data from the remote sensing survey to determine the location of hydrocarbon seeps into the sea. The remote sensing survey may include performing one or more of ocean acoustic waveguide survey; water column seismic survey; active acoustic sensing survey; imagery and spectrometry of slicks and atmospheric gas plumes; passive acoustic sensing survey; magnetic and gravity surveys; optical sensing survey and thermal anomalies detection survey. These surveys include seismic and acoustic imaging of seeps in the water column, performed in ship-based marine vessels, using multibeam echo sounder and/or side-scan sonar.

There is a need to improve on these surveys.

### SUMMARY OF THE INVENTION

In a first aspect, there is provided a method of detecting a stream of bubbles emanating from a bubble source into a body of sea water below a sea surface and above a sea floor, comprising:
emitting an outgoing acoustic wave using a transmitter array comprising one or more acoustic transducers deployed within a SOFAR channel in the body of sea water;
receiving reflected acoustic waves using a receiver array comprising one or more acoustic transducers deployed within the SOFAR channel and outputting receiver signals correlating with the acoustic waves;
selecting from the receiver signals contributions of those acoustic waves that have reflected off of a stream of bubbles traversing the SOFAR channel.

In a second aspect, there is provided a system for detecting a stream of bubbles emanating from a bubble source into a body of sea water, comprising:
a transmitter array comprising one or more acoustic transducers deployed within a SOFAR channel in the body of sea water;
a receiver array comprising one or more acoustic transducers deployed within the SOFAR channel;
a computer arranged to process receiver signals from the receiver array and programmed to select contributions to these signals from acoustic waves that have reflected off of a stream of bubbles traversing the SOFAR channel.

### BRIEF DESCRIPTION OF THE DRAWING

The appended drawing, which is non-limiting, comprises the following figures:

FIG. 1 schematically shows an impression of the system and method deployed from a vessel;

FIG. 2 schematically shows an enlarged view of a transmitter array and a receiver array deployed within the SOFAR channel;

FIG. 3 schematically shows an impression of the system and method moored on the sea floor;

FIG. 4 shows a broadside radiation pattern for an implementation of FIG. 2;

FIG. 5 (parts A and B) shows results of acoustic power as function of range from the transmitter array for two different depths of the SOFAR channel, and for two acoustic wave frequencies.

The figures are schematic in nature, and not to scale. Like reference numbers are used for like features.

### DETAILED DESCRIPTION OF THE INVENTION

The invention will be further illustrated hereinafter by way of example only, and with reference to the non-limiting drawing. The person skilled in the art will readily understand that, while the invention is illustrated making reference to one or more a specific combinations of features and measures, many of those features and measures are functionally independent from other features and measures such that they can be equally or similarly applied independently in other embodiments or combinations.

A method and system are presently proposed, wherein a transmitter array of acoustic waves as well as a receiver array for acoustic waves is deployed at a depth within the SOFAR channel in the body of sea water. Contributions to the receiver signals originating from acoustic waves that have reflected off of a stream of bubbles traversing the SOFAR channel are identified and isolated from the receiver signals.

In this context, the term “bubbles” is used for vapour filled bubbles as well as liquid droplets. The bubbles may or may not be at least partially frozen. In case of hydrocarbon containing bubbles, the bubbles may at least partially be in the form of hydrocarbon hydrates, such as methane hydrates.

Advantages of deploying the transmitter array as well as the receiver array within the SOFAR channel may include:
the acoustic waves may be trapped in the SOFAR channel and travel long distances;
reflections from the sea surface as well as the sea floor are reduced relative to reflections from objects within the SOFAR channel.

These advantages contribute to the ability of long-range detection (>5 km, preferably >25 km) of bubble streams emanating from seeps, such as seeps originating from natural hydrocarbon sources from the sea floor, or seeps from under-water infrastructure confining hydrocarbons such as pipelines. The method and system may be useful not only for exploration purposes, but also for surveillance around off-shore hydrocarbon drilling and production facilities. The ability of said long-range detection within the SOFAR channel does not negate the possibility of the method and system also providing for detection at shorter ranges, even down to tens of meters and/or into the near field regime, in or outside the SOFAR channel.

Where it exists, the SOFAR channel is centred on the depth at which the speed of sound reaches a minimum relative to its values above and below in the water column.

Without wishing to be bound by a particular theory of origin, it is currently believed that a cumulative effect of temperature gradient (thermocline) and water pressure gradient (pycnocline), and, to a lesser extent, salinity gradient (halocline), combines to create a layer of minimum sound speed in the water. Falling temperature with depth causes a decrease in sound speed, a negative sound speed gradient. Increasing pressure with depth causes an increase in sound speed, or a positive sound speed gradient. The depth where the sound speed depth-gradient is zero (i e a minimum in the sound speed) is referred to herein as the “SOFAR plane”. The SOFAR plane is not necessarily a flat plane at a fixed depth, but it can fluctuate both in time as well as laterally. Acoustic waves can propagate long distances within the SOFAR channel, confined within the SOFAR channel by an acoustic wave guiding effect, with relatively little attenuation.

In insufficiently deep water, there might not exist a SOFAR channel, for instance if the pressure increase at the sea floor is insufficient to offset the thermocline. While this also provides a wave guiding effect for sound waves, this is less preferred as such waveguide would be located directly adjacent to sea floor. As a result, reflections of guided waves come with relatively high reflections from the sea floor. Accordingly, it is preferred that the body of water be sufficiently deep for the SOFAR channel to exist and be sufficiently removed from the sea floor to avoid sea floor reflections that may mask comparatively weak reflections from bubbles traversing the SOFAR channel. The SOFAR plane is preferably at least 400 m, more preferably at least 600 m, distant from the sea floor in any of the geographical locations under investigation, to keep contributions to the received signals from bottom-reflections to an acceptable limit.

Acoustic wave guiding conditions may also exist within a mixed water layer at the top of the water column under the influence of combined actions of wind and waves. However, also surface reflections may mask signal from a bubble stream and thus this mechanism of acoustic wave guiding is typically less preferred than wave guiding in the SOFAR channel. The SOFAR plane is preferably at least 300 m, preferably at least 400 m, distant from the sea surface. In addition, any bubble stream that has emerged from a seep at a depth is less likely to have dissolved than near the surface. Dissolution tends to be accelerated near the surface.

It has been found that frequencies of between 0.8 kHz and 10 kHz provide the best results in terms of a combination of detection range and echo strength from bubble streams.

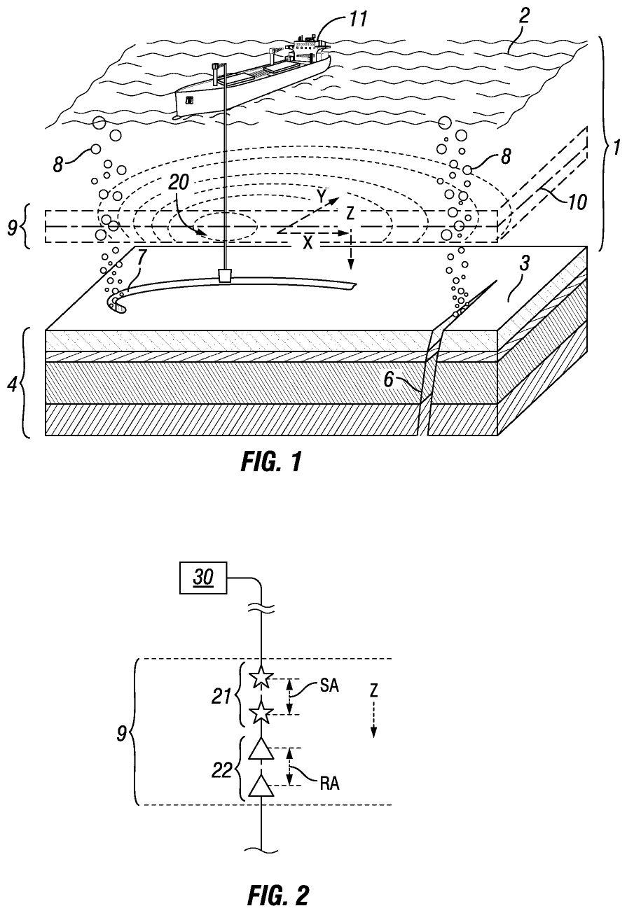

FIG. 1 schematically illustrates some of these concepts. 1. A body of sea water 1 extends below a sea surface 2 and above a sea floor 3. Below the sea floor are earth formations 4 built up from sediments and layers. Natural seeps of hydrocarbons may be released from sub sea floor hydrocarbon reservoir rocks, for instance through seeps paths provided by a geologic fault 6 or through man-made holes. Seepages of hydrocarbons may also be released from infrastructure, such as the flow line 7 on the sea floor 3 shown in FIG. 1. Such seepages can manifest in the form of a stream of bubbles 8, typically rising upward from a seep source though the sea water. Earlier experiences have confirmed that bubbles of methane gas or gas hydrates typically have volumes commensurate with those of spheres between 2 mm and 8 mm in diameter, averaging around about 6 mm in diameter. These bubbles may typically rise through the water column at a velocity of about 0.2 m/s.

The SOFAR channel 9 is formed by a water layer extending over two lateral directions (x,y) and having a thickness direction (z) perpendicular to the two lateral directions in each lateral location. A SOFAR plane 10 is defined in the body of sea water 1, as a continuous two-dimensional sheet below the sea surface 2, spanning over a range of geographical locations in the body of sea water 1, wherein the depth-gradient of the acoustic velocity is zero and the acoustic velocity of the outgoing acoustic waves is lower than in any other depth. The SOFAR plane 10 is fully embedded within the SOFAR channel 9. In FIG. 1 the SOFAR channel is schematically represented dashed lines. However, in reality the SOFAR channel is not bound by distinct sharp boundaries, but rather by sound speed gradients decreasing above and increasing below the SOFAR plane 10.

An active array 20 is deployed within the SOFAR channel. In the embodiment of FIG. 1, the active array 20 is suspended from a vessel 11. As illustrated in FIG. 2, the active array 20 may comprise both a transmitter array 21 and a receiver array 22. The transmitter array 21 and the receiver array 22 may each have its own dedicated transducers, or transducers may be shared between the transmitter array 21 and the receiver array 22. Alternatively, the transmitter array may be deployed on a different line than the receiver array and/or in different locations. For practical reasons, the transmitter array 21 and the receiver array 22 may preferably be deployed within a lateral proximity from each other of less than 100 m. This allows both arrays to be deployed from the same vessel, for instance. When a free floating (unanchored or loosely anchored) vessel is used to deploy the active array 20, it is preferably equipped with dynamic positioning capabilities to keep the active array 20 sufficiently stationary during a period of several hours while making acoustic measurements.

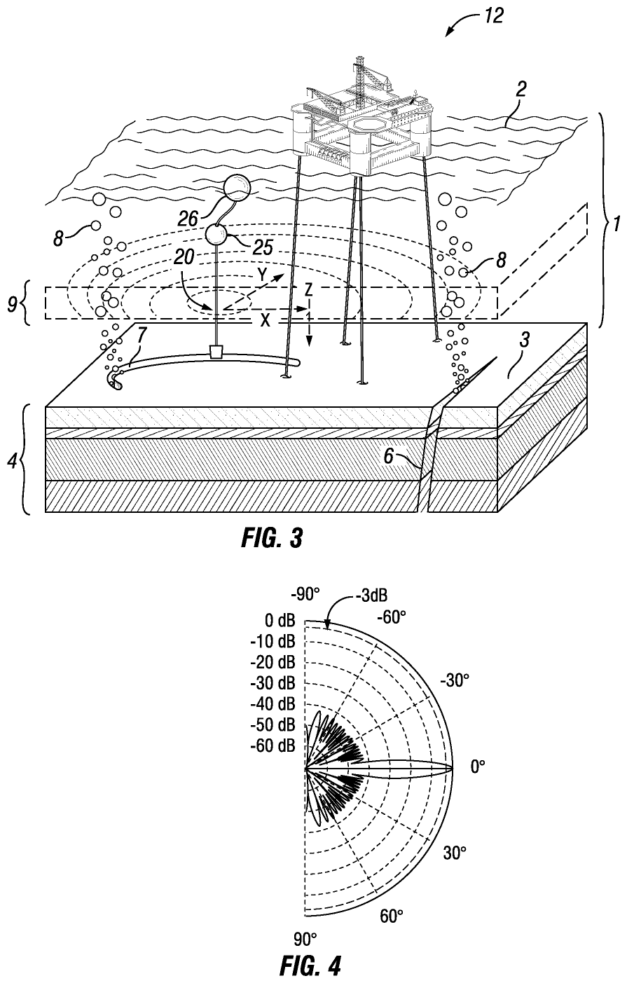

As illustrated in FIG. 3, the active array 20 may also be moored on the sea floor 3, suitably using a subsurface float 25. In practice, the location of the active array 20 may be marked using a buoy 26. This option may be attractive for permanent areal surveillance around or in the vicinity of, for instance, a production platform 12 or other infrastructure of interest. The active array may also be deployed from the production platform. Multiple of such active arrays 20 may be deployed.

The outgoing acoustic waves are preferentially emitted in a radiation pattern that is predominantly directed within the SOFAR channel 9 and preferably along the SOFAR plane 10. This is schematically illustrated in FIG. 1 by means of the oval lines representing circular wave-fronts centered around the active array 20. The transmitter array is configured to create a radiation pattern that is predominantly confined within the SOFAR channel 9. The radiation pattern is preferably emitted in all lateral directions (x,y), and predominantly parallel the SOFAR plane 10. Various array configurations can achieve this. In one example, the transmitter array 21 extends in the thickness direction z as shown in FIG. 2. A relatively large transmitter array aperture SA may be selected. The transmitter array effect of the collective transducers within the array may be used to create the desired radiation pattern.

The radiation pattern in broadside view may for instance have a half-power angular beam-width of no more than 5°, meaning in some embodiments that a majority of acoustic power is emitted along the SOFAR plane 10 within 2.5° on either side of the SOFAR plane 10. Half-power angular beam width is generally defined as an angular segment including the angle of maximum transmission wherein an acoustic power is between the half-power points (i.e. between 0 and −3 dB) from the acoustic power at the angle of maximum transmission. The outgoing acoustic waves may be actively steered away from broadside direction, using known beam forming techniques. These make use of manipulated phase differences across mutually adjacent transducers within the transmitter array 21.

Similar beam width and deployment considerations apply to the receiver array 22, to directionally selectively receive reflected acoustic waves propagating primarily within the SOFAR channel 9 along a path reciprocal to that of the emitted outgoing acoustic waves. The directional selectivity may be directed away from broadside, by applying similar beam forming techniques on the transducers in the receiver array 22. As with the transmitter array, it is preferred to choose a relatively large receiver array aperture RA. The receiver array aperture RA can be, but is not necessarily, equal to the transmitter array aperture SA.

In practice, the transmitter array 21 or the receiver array 22, or both the transmitter array 21 and the receiver array 22, each extend over an aperture of at least 10 wavelengths, preferably at least 16 wavelengths, of the emitted outgoing acoustic waves. Suitably, the wavelength of the center frequency of the acoustic emission spectrum is taken as reference. For this purpose, the center frequency is defined as the geometric average of the −3 dB frequencies (half-power frequencies) of the main lobe in the acoustic emission spectrum.

Emitted outgoing acoustic waves which are guided within the SOFAR channel 9 may reflect off regions within the SOFAR channel 9 that have a different acoustic impedance. This can include a stream of bubbles 8 that traverses the SOFAR channel 9. The reflected acoustic waves from all reflectors are received with the receiver array and transduced to receiver signals representative of those received acoustic waves. Receiver signals that correlated with the transmitted acoustic waves are retained. If a stream of bubbles 8 traverses the SOFAR channel 9, the receiver signals will also contain contributions of those acoustic waves that have been reflected off of the stream of bubbles. These contributions are selected from the receiver signals. This can be done in a variety of ways taking advantage of the specific properties of the bubble stream.

For instance, the spectral response of the reflected signals can be used to identify whether the reflected acoustic wave can be attributed to a stream of bubbles. Modelling and previous investigations have shown that bubble streams nurtured by methane-containing seepages in the sea form elongate approximately cylindrical plumes that have have a typical lateral diameter in the range of meters (e.g. between 5 and 10 m) while extending over hundreds of meters in longitudinal direction along the plume. The plume is not necessarily aligned with the vertical, but it can deviate while approximately preserving its typical diameter. The combined system of such a plume in the sea water is prone to have vibrational modes that are unique to such shapes.

Other properties can be used in addition, or instead, thereof to identify and isolate those portions of the receiver signals that represent reflections from the stream of bubbles. For instance, a stream of bubble is not expected to move in lateral directions in the same way as other potential reflecting bodies or assemblages, and therefore target persistence is another way to select signal contributions from bubble streams.

The method is expected to work best when the SOFAR plane extends at depths where stable hydrates form upon contact of methane with the sea water. Such hydrates tend to form a shell or a partial shell around each bubble, as a result of which the bubbles will have higher resistance against dissolution. As a rule of thumb, this means that it is most preferred when the SOFAR channel is at least 600 m distant from the sea surface. Modelling has shown that stable methane hydrates in the world's seas are generally most likely to exist below 600 m and not above 400 m depth. Empirical formulas published by Dickens and Quinby-Hunt (Geophysical Research Letters Vol. 21(19), pp. 2115-2118, 1994) for the depth dependence of methane hydrate stability in seawater as a function of temperature, or temperature and salinity as published by Tishchenko et al (Chemical Geology Vol. 219(1-4), pp. 37-52, 2005), were used with the decadal annual mean profiles of temperature and salinity to estimate the water column depths at which methane hydrate is likely to exist in the areas of interest. In cases considered by Applicant, hydrate stability was found to end at the depth where the seawater temperature is between approximately 7.0 and 7.3° C. This was found to correspond to typical depths of between 600 m and 620 m below sea surface.

The depth of the SOFAR plane can be determined using data from for instance the World Ocean Atlas, issued by the U.S. National Oceanographic Data Center.

Referring again to FIG. 2, in one possible implementation of the active array 20 the transmitter array 21 may be implemented in the form of a line comprising 24 acoustic transmitters positioned with 38.7 cm center-to-center spacing. The receiver array 22 may be based on for instance 24 hydrophones, also positioned with 38.7 cm center-to-center spacing. The center-to-center spacing between adjacent hydrophones and/or between adjacent acoustic transmitters, may correspond to 0.8 wavelengths. With 24 pieces of each, this results in an aperture length of about 19.2 wavelengths. Additional array equipment, including electronics, roll/pitch sensors, floats and ballast weight may be provided in accordance with regular practices in the art. Suitably the acoustic transmitters may be of booted free-flooding ring (FFR) type, obtainable from various providers, such as GeoSpectrum Technologies Inc. and Applied Physical Sciences Corp. The entire line may be connected (e.g. electrically and/or optically) to control unit 30. Suitably the control unit 30 may comprise a power supply, a computer, network converters (e.g. an Ethernet converter or optical Ethernet converter). The computer in the surface control unit 30 is suitably arranged to process receiver signals from the receiver array. It may particularly be programmed to select the contributions to the signals from acoustic waves that have reflected off of a stream of bubbles traversing the SOFAR channel.

FIG. 4 shows the broad side radiation pattern of the implementation of the active array 20 as described in the previous paragraph. Radiative power is plotted in radial direction relative to the maximum radiate power (in dB). The radiation pattern has a main lobe, and a number of side lobes each being more than 40 dB weaker than the main lobe. Generally, it is sufficient if radiative power of all present side lobes is weaker than −20 dB than the radiative power at the angle of maximum transmission in the main lobe. The main lobe beam width of the unshaded array is about 2.6°. Side lobe control with a Hanning window broadens the beam width to about 4° which is what is shown in FIG. 4. Generally, it is sufficient if the main lobe has an angular half-power beam width of no more than 5°.

One-way transmission loss has been estimated by computing complex pressure along ray paths over a range of 50 km for launch angles within ±60° of horizontal at 1° increments. For this the acoustic transmitter array was assumed to be located at the SOFAR plane in a range-independent environment. The calculations were done with coherent ray-tracing runs (for instance Lei Dong and Hefeng Dong in “Bellhop—A modeling approach to Sound propagation in the ocean”, published in in 37^{th} Scandinavian Symposium on Physical Acoustics, February 2014). The water column was modeled as a vertically stratified medium described by the decadal annual depth profile of sound speed, a frequency-dependent acoustic absorption profile, and water density at the sea floor. The sea floor was modeled as a homogeneous half-space of very fine sand/silt (mean grain size about 4 phi). Compressional and shear wave speeds and attenuations in the sediment were computed with empirical relationships of sound speed and attenuation ratios vs. mean grain size derived from high-frequency (>10 kHz) sea floor acoustics (as described in e.g. pages 313-314 of Jackson & Richardson, “High-Frequency Seafloor Acoustics”, Springer, 2007).

The results of the calculations confirm that rays within a few degrees of horizontal travel down the SOFAR channel. Rays launched above the SOFAR plane are refracted downward due to the strong sound speed gradient. As a result, only the steepest rays reach the sea surface and are attenuated on subsequent bounces between the bottom and the sea surface. Therefore, the sea surface is not expected to affect long-range transmission loss along the SOFAR channel. Rays launched below the SOFAR plane are refracted upward because of a positive sound speed gradient. The steepest rays are reflected on the bottom, turn upward and are refracted downward before they reach the sea surface.

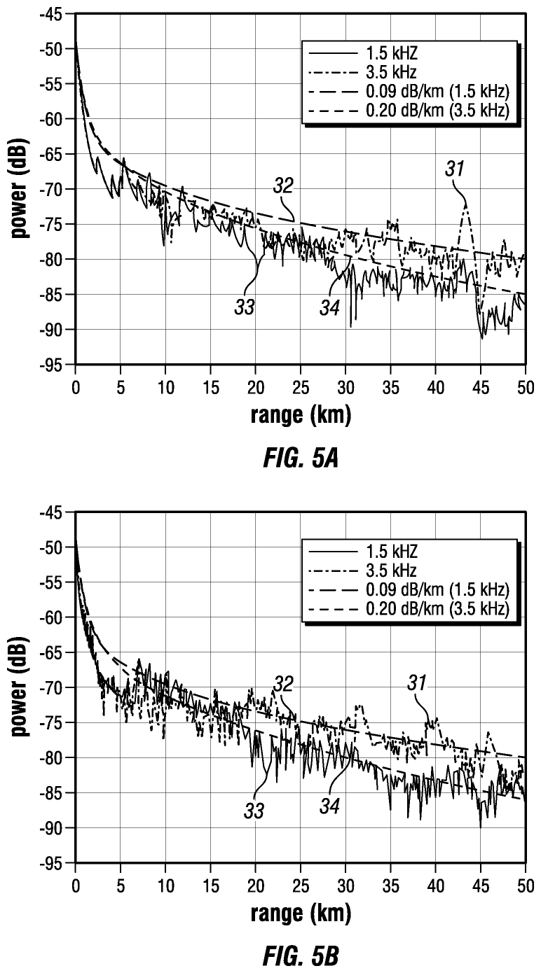

FIG. 5A shows transmission loss of the transmitter array with the radiation pattern of FIG. 4, placed on a SOFAR plane at 750 m depth. Transmission loss for two frequencies (1.5 kHz and 3.5 kHz) are shown. Transmission loss for acoustic waves that travel near the SOFAR plane is about 80 dB at 1.5 kHz (see FIG. 5A line 31) and 85 dB at 50 km range (see FIG. 5A line 33). FIG. 5B shows results of similar calculations for a different SOFAR channel in a different location, where the transmitter array was placed on the SOFAR plane at a depth of 900 m. The sound speed profile in this example was more symmetrical around the SOFAR plane. The transmission loss at the 50 km range is almost the same as in the case of FIG. 5A. In both FIGS. 5A and 5B, transmission losses shown in lines 31 and 33 represent transmission losses as averaged over a 16 m depth interval centered on the SOFAR plane.

To first approximation, the transmission loss can be modeled with a straight forward spreading and absorption loss formula along the SOFAR plane (represented by the dashed lines 32 and 34 in FIGS. 5A and 5B):

TL(r)=20 log₁₀(s_{d})+10 log₁₀(r/s_{d})+α(f,s_{d});

wherein TL stands for transmission loss (in dB) and r is the lateral range measured from the transmitter array (in meters), s_{d} is the transmitter depth (in meters), and a an acoustic absorption coefficient (in dB/m), which depends on frequency f, and temperature, salinity, pressure, and pH at the transmitter depth s_{d}.

It should be understood that FIG. 2, and the specific dimensions and other particulars set forth herein, are merely one possible implementation serving as example and not intended to exclude alternative array parameters and implementations.

Generally, the transducers in the transmitter array and the receiver array may be capable of both transmitting and receiving. However, the transducers used in the transmitter array may be selected from the group of transmitters that are generally unsuitable for receiving. Likewise, the transducers used in the receiver array may be selected from the group of receivers that are generally unsuitable for transmitting. The receiver array may consist of discrete transducers, such as geophones or hydrophones, or of a continuous distributed transducer which can be divided into “receiver channels”. An example is distributed acoustic sensing (DAS) by fiber optics. Various DAS cables with broadside acoustic sensitivity, which would be an advantageous property for the presently proposed methods and systems, have been proposed and described in for instance: U.S. Pat. Nos. 9,091,589; 9,494,461; 9,322,702; and US patent application publication No. 2015/0260567. A preferred option is a DAS cable having one or more helically-wound optical fibers, as described in U.S. Pat. No. 9,494,461.

The person skilled in the art will understand that the present invention can be carried out in many various ways without departing from the scope of the appended claims.

1. A method of detecting a stream of bubbles emanating from a bubble source into a body of sea water below a sea surface and above a sea floor, comprising:
emitting an outgoing acoustic wave using a transmitter array comprising one or more acoustic transducers deployed within a SOFAR channel in the body of sea water;
receiving reflected acoustic waves using a receiver array comprising one or more acoustic transducers deployed within the SOFAR channel and outputting receiver signals correlating with the acoustic waves;
selecting from the receiver signals contributions of those acoustic waves that have reflected off of a stream of bubbles traversing the SOFAR channel.

2. The method of claim 1, wherein the SOFAR channel is formed by a water layer extending over two lateral directions and having a thickness direction perpendicular to the two lateral directions in each lateral location.

3. The method of claim 2, wherein a SOFAR plane is defined in the body of sea water as a collection of water depths, for a range of geographical locations in the body of sea water, wherein a speed of sound is lower than at any other depth above and below said collection, and wherein the SOFAR plane is fully embedded within the SOFAR channel.

4. The method of claim 3, wherein the SOFAR plane extends at depths where stable hydrates form upon contact of methane with the sea water.

5. The method of claim 3, wherein the SOFAR plane is at least 400 m distant from the sea floor in any of said of geographical locations and/or at least 300 m distant from the sea surface in any of said of geographical locations.

6. The method of claim 2, wherein the outgoing acoustic waves are emitted in a radiation pattern that is predominantly directed within the SOFAR channel along the SOFAR plane, and wherein the receiver array directionally selectively receives reflected acoustic waves propagating within the SOFAR channel along paths reciprocal to those of the outgoing acoustic waves.

7. The method of claim 6, wherein the radiation pattern in broadside view has a main lobe and optionally any number of side lobes, wherein the main lobe has an angular half-power beam width of no more than 5°, wherein angular beam width is defined as the angle subtended by the half-power points (−3 dB) on either side of the direction of maximum acoustic transmission power in the radiation pattern.

8. The method of claim 7, wherein radiative power of all present side lobes is weaker than −20 dB of the radiative power at the direction of maximum acoustic transmission.

9. The method of claim 6, further comprising actively steering the outgoing acoustic wave and/or the receiver array directional selectivity.

10. The method of claim 2, wherein the transmitter array and the receiver array extend in the thickness direction.

11. The method of claim 12, wherein transmitter array or the receiver array, or both the transmitter array and the receiver array, each extend over an aperture of at least 10 wavelengths of the emitted outgoing acoustic waves.

12. The method of claim 2, wherein the transmitter array and the receiver array are deployed in a lateral proximity from each other of less than 100 m.

13. The method of claim 2, wherein the stream of bubbles is in excess of 5 km removed from each of the transmitter array and the receiver array in the lateral directions.

14. The method of claim 1, wherein the outgoing acoustic waves have frequency of between 0.8 kHz and 10 kHz.

15. The method of claim 1, wherein the bubbles comprise methane.

16. A system for detecting a stream of bubbles emanating from a bubble source into a body of sea water, comprising:
a transmitter array comprising one or more acoustic transducers deployed within a SOFAR channel in the body of sea water;
a receiver array comprising one or more acoustic transducers deployed within the SOFAR channel;
a computer arranged to process receiver signals from the receiver array and programmed to select contributions to these signals from acoustic waves that have reflected off of a stream of bubbles traversing the SOFAR channel.
